(19) United States
(12) Patent Application Publication
(10) Pub. No.: US 2016/0371365 A1
(43) Pub. Date: Dec. 22, 2016

(54) SYSTEMS AND METHODS FOR REPRESENTING RELATIONSHIPS BETWEEN MULTIPLE CORRELATED CATEGORIES

(71) Applicants: VALERIE LANDEAU, ALAMEDA, CA (US); DANIEL CHAPMAN, APTOS, CA (US); PENNY BAMFORD, BERKELEY, CA (US)

(72) Inventors: VALERIE LANDEAU, ALAMEDA, CA (US); DANIEL CHAPMAN, APTOS, CA (US); PENNY BAMFORD, BERKELEY, CA (US)

(21) Appl. No.: 14/281,850

(22) Filed: May 19, 2014

(51) Int. Cl. G06F 17/30; G09B 5/02

(52) U.S. Cl. CPC G06F 17/30601; G06F 17/30557; G09B 5/02

(57) ABSTRACT

A data presentation and interaction system and method provides data interaction that enables users understand multiple correlations between items in multiple categories by using proximity, grouping, audio or visual icons to represent items.

### CROSS REFERENCE TO RELATED APPLICATIONS

This application claims priority from provisional patent application 61/855,533 filed May 18, 2014 and entitled METHOD FOR REPRESENTING RELATIONSHIPS BETWEEN MULTIPLE CORRELATED CATEGORIES. All referenced documents and application herein and all documents referenced therein are incorporated in by reference for all purposes. This application may be related to other patent applications and issued patents assigned to the assignee indicated above. These applications and issued patents are incorporated herein by reference to the extent allowed under applicable law.

### PRECAUTIONARY REQUEST TO FILE AN INTERNATIONAL APPLICATION, DESIGNATION OF ALL STATES, AND STATEMENT THAT AT LEAST ONE APPLICANT IS A UNITED STATES RESIDENT OR ENTITY

Should this document be filed electronically or in paper according to any procedure indicating an international application, Applicant hereby requests the filing of an international application and designation of all states. For purposes of this international filing, all inventors listed on a cover page or any other document filed herewith is applicants for purposes of United States National Stage filing. For purposes of this international filing, any assignees listed on a cover page or any other document filed herewith are applicants for purposes of non-United States national stage filing, or, if no assignee is listed, all inventors listed are applicants for purposes of non-United States national stage filing. For purposes of any international filing, applicants state that at least one applicant is a United States resident or United States institution. Should this application be filed in as a national application in the United States, this paragraph shall be disregarded.

### COPYRIGHT NOTICE

Pursuant to 37 C.F.R. 1.71(e), applicant notes that a portion of this disclosure contains material that is subject to and for which is claimed copyright protection (such as, but not limited to, source code listings, screen shots, user interfaces, or user instructions, or any other aspects of this submission for which copyright protection is or may be available in any jurisdiction.). The copyright owner has no objection to the facsimile reproduction by anyone of the patent document or patent disclosure, as it appears in the Patent and Trademark Office patent file or records. All other rights are reserved, and all other reproduction, distribution, creation of derivative works based on the contents, public display, and public performance of the application or any part thereof are prohibited by applicable copyright law.

### APPENDIX

This application is being filed with an electronic appendix. This appendix and all other papers filed herewith, including papers filed in any attached Information Disclosure Statement (IDS), are incorporated herein by reference. The appendix sets out selected source code extracts from a copyrighted software program that manifests specific example implementations and embodiments.

Permission is granted to make copies of the appendices solely in connection with the making of facsimile copies of this patent document in accordance with applicable law; all other rights are reserved, and all other reproduction, distribution, creation of derivative works based on the contents, public display, and public performance of the appendix or any part thereof are prohibited by the copyright laws.

### FIELD OF THE INVENTION

The present invention relates to logic systems and presentation of data stored on logic system. More particularly, it relates to logic systems such as computer systems, tablet systems, and smartphone systems, and associated systems and methods that present data to one or more users statically and/or interactively. In further embodiments, one or more methods may be implemented on a data handling device or system, such as a computer or other information enabled device. In further embodiments, methods and/or systems involve performing one or more data interactions at one or more information devices and optionally over a communication network.

### BACKGROUND

The discussion of any work, publications, sales, or activity anywhere in this submission, including in any documents submitted with this application, shall not be taken as an admission that any such work constitutes prior art. The discussion of any activity, work, or publication herein is not an admission that such activity, work, or publication existed or was known in any particular jurisdiction.

In the past it has been difficult for people to grasp relationships between items in several categories with correlations to many items in each category. It is easy to show how items are related in hierarchical structures when the relationship is one to many (such as a tree diagram), or how many individual categories overlap (such as a Venn diagram) but displaying the relationship between categories of many-to-many gets confusing very quickly.

### SUMMARY

Specific embodiments involve methods and/or systems and/or devices that can be used together or independently to provide presentation or interaction between users and data that is correlated in complex ways. This Summary introduces a selection of concepts in a simplified form that are further described below in the Detailed Description. This Summary is not intended to identify essential or key or necessary features of the claimed subject matter, nor is it intended to be determinative of the scope of the claimed subject matter.

The present invention may be embodied as a method or device or system or apparatus for presenting data to a user and/or allowing user interaction with data. According to specific embodiments, the method or system involves logic that reads data from a computer readable tangible medium and provides a presentation allowing easier user understanding or comprehension of that data. Further embodiments enable user input selecting various ways of presenting correlated data from multiple categories. The invention may also be embodied as a computer program product for presenting data to one or more users or allowing a one or more users to interact with data. The computer program product includes a computer usable or readable media including computer usable program code to cause the computer to operate as herein described.

Specific embodiments involve a method of displaying and/presenting data involving multiple categories in a way that is easy to understand and makes it easier to users to comprehend the relationships of multiple categories of items that align with or are correlated to items in multiple categories. Specific embodiments for representing the relationships between items in multiple correlated categories help people see how items in distinct categories are related using novel representations of the data. One example software system that includes specific embodiments of the present invention is referred to as Mosaic View™. A further example software system that includes specific embodiments of the present invention is referred to as Mosaic Data Sonification™.

According to specific embodiments, one or more categories of items are represented by a type of icon or text or other representation that is generally distinct in some aspect for that for that category (e.g., text, a group, an icon, a set of icons, a sound, etc.).

Items within categories are generally represented by the representation for that category, with specific variations for each item (e.g. color, size, shape, proximity, sound, sensory output or haptic feedback). As described below, items in one or more categories may be represented by a non-variable icon. As described below, items in one or more categories may be represented by a group.

In general, in presentations according to specific embodiments, where one of the categories is represented as a group, when there is a correlation with items from the other categories, that item's icon is represented in the group. This method helps users see relationships of groups of items that have multiple items correlated to other groups with multiple items. It facilitates understand of the relationships of many to many in several categories or types of data.

Specific embodiments further provide a better user experience with multiply-correlated data by novel data representations. In specific embodiments, three broad categories levels of data are presented, referred to at times herein as Category Level 1 (C1), Category Level 2(C2), and Category Level 3(C3). Each category contains a plurality of data items. Category 1 data items generally involve very broad concepts or ideas or things that are related to data items in the other categories and also to one another. In an institutional setting, Category 1 items can involve institutional goals. Category 2 data items generally involve concepts or ideas or things that are related to data items in the other categories and also to one another but that are more specific in some way than Category 1 data. In an institutional setting, Category 2 items can involve departmental level goals. Category 3 data items generally involve concepts or ideas or things that are related to data items in the other categories and are the most specific in the presentation. In some situations, Category 3 data items may be outcomes or characteristics that are measureable or evidence based, such as meeting sales goals or educational assessment goals. At times in this discussion, “Category Level” and “Category” are used interchangeable. In specific embodiments and implementations, as will be understood from the discussion herein, there may be multiple distinct categories in each Category Level.

According to specific embodiments, in a data presentation or interaction, each item in Category Level 1 is represented as icon or sensory stimulus that varies per item. For example, musical notes or icons with varying shapes or shading.

According to specific embodiments, in a data presentation or interaction, each item in Category Level 2 is represented as a group. The group may appear in a visual or printed output as a distinct grouping with borders or as a proximity grouping without borders. The group may be presented in sensory output as distinct sensory stimuli, such as notes played together as a chord or individually for each group. The group may be also presented in sensory output as distinct sensory stimuli, such as number, length, strength of vibration patterns or haptic feedback.

According to specific embodiments, in a data presentation or interaction, each item in Category Level 3 is represented as a generally non-distinct icon. (By generally non-distinct, is meant less distinct than Level 1 icons, though variations in Level 3 icons are present in some embodiments.) These items may appear in a visual or printed output as a group of icons with little to no distinction. When viewing Level 2 items, the count or number of Level 3 items can aid in the visualization and understanding of the data. According to specific embodiments, Level 3 items are often associated with one or more details or evidence that will appear in a pop-up window in some presentations or may be presented in a list fashion.

According to specific embodiments, the representations described above facilitate presentation of data to groups of stakeholders. As described below, grouping Level 1 icons and Level 3 icons in Level 2 groups provides easier understanding of data to groups of users.

Including in the output of data sensory stimuli, such as sound or vibration, increases understanding and engages audiences more fully than textual presentations. Furthermore, with data represented and organized as described above, a number of interactive presentations or “games” may be used to increase audience engagement and understanding.

The general structure and techniques, and more specific embodiments that can be used to effect different ways of carrying out the more general goals are described herein. Although only a few embodiments have been disclosed in detail herein, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art.

The inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation . The computer may be an Intel (e.g., Pentium or Core 2 duo) or AMD based computer, running Windows XP or Linux, or may be a Macintosh computer. The computer may also be a handheld computer, such as a PDA, cellphone, or laptop.

Various specific embodiments provide methods and/or systems and/or apparatus for presenting or representing data that can be implemented on a general purpose or special purpose information handling appliance or logic enabled system, such as a laboratory or diagnostic or production system, using a suitable programming language such as Java, C++, C#, Cobol, C, Pascal, Fortran., PL1, LISP, assembly, etc., and any suitable data or formatting specifications, such as HTML, XML, dHTML, TIFF, JPEG, tab-delimited text, binary, etc. In the interest of clarity, not all features of an actual implementation are described in this specification. It will be understood that in the development of any such actual implementation (as in any software development project), numerous implementation-specific decisions must be made to achieve the developers' specific goals and subgoals, such as compliance with system-related and/or business-related constraints, which will vary from one implementation to another. Moreover, it will be appreciated that such a development effort might be complex and time-consuming, but would nevertheless be a routine undertaking of software engineering for those of ordinary skill having the benefit of this disclosure.

Where a specific numerical value is mentioned or illustrated herein, it should be considered that the value may be increased or decreased by 20%, while still staying within the teachings of the present application, unless some different range is specifically mentioned. Where a specified logical sense is used, the opposite logical sense is also intended to be encompassed.

Systems and methods according to specific embodiments and various specific aspects and embodiments will be better understood with reference to the following drawings and detailed descriptions. For purposes of clarity, this discussion refers to devices, methods, and concepts in terms of specific examples. However, these systems and methods and aspects thereof may have applications to a variety of types of devices and systems. It is therefore intended that the scope of the invention not be limited except as provided in the attached claims and all allowable equivalents.

Furthermore, it is well known in the art that logic systems and methods such as described herein can include a variety of different components and different functions in a modular fashion. Different example specific embodiments and implementations can include different mixtures of elements and functions and may group various functions as parts of various elements. For purposes of clarity, embodiments of the invention are described in terms of systems that include many different innovative components and innovative combinations of innovative components and known components. No inference should be taken to limit the claimed invention to combinations containing all of the innovative components listed in any illustrative embodiment in this specification.

In some of the drawings and detailed descriptions below, the present invention is described in terms of the important independent embodiment of a system operating on a digital data network. This should not be taken to limit the claimed invention, which, using the teachings provided herein, can be applied to other situations, such as cable television networks, wireless networks, etc. Furthermore, in some aspects, the present invention is described in terms of client/server systems. A number of computing systems and computing architectures are described in the art as client/server art. For the purposes of this description, client/server should be understood to include any architecture or configuration wherein an element acting as a client accesses a remote and/or separate program or device that is providing the desired service (e.g., a server).

All references, publications, patents, and patent applications cited herein are hereby incorporated by reference in their entirety for all purposes.

### BRIEF DESCRIPTION OF THE DRAWINGS

FIG. 1A-B illustrate examples of category representations and presentations according to specific embodiments.

FIG. 2A-E illustrate examples of views (e.g. a Mosaic View™) presenting relationships of items in various correlated categories according to specific embodiments.

FIG. 3 illustrates an example of presenting relationships of items in categories in a list view according to specific embodiments.

FIG. 4A-B illustrate examples of presenting a number of items in a group category showing alignment or membership of items in other categories according to specific embodiments.

FIG. 5A-D illustrate examples of presenting items in a group category indicated by columns optionally for display along with a sound output according to specific embodiments.

FIG. 6 illustrates an example simple data input template for entering and from which can be read items and categories according to specific embodiments.

FIG. 7 illustrates an example architecture of an example information handling system relevant to various specific embodiments.

FIG. 8 is a block diagram showing a representative example logic device in which various aspects of specific embodiments may be implemented.

### DESCRIPTION OF SPECIFIC EMBODIMENTS

Before describing the present invention in detail, it is to be understood that this invention is not limited to particular methods or systems, which can, of course, vary. It is also to be understood that the terminology used herein is for the purpose of describing particular embodiments only, and is not intended to be limiting. As used in this specification and the appended claims, the singular forms “a”, “an” and “the” include plural referents unless the content and context clearly dictates otherwise. Thus, for example, reference to “a device” or “a system” includes a combination of two or more such devices, and the like.

Unless defined otherwise, technical and scientific terms used herein have meanings as commonly understood by one of ordinary skill in the art to which the invention pertains. Although any methods and devices or systems similar or equivalent to those described herein can be used in practice or for testing of the present invention, the preferred materials and methods are described herein.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks

### DETAILED DESCRIPTION

### 1. Overview

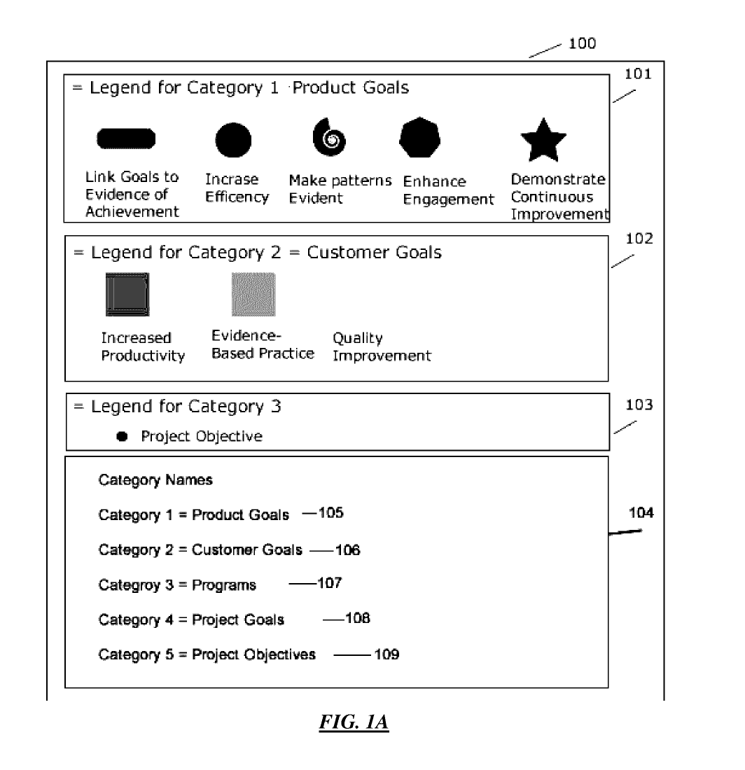

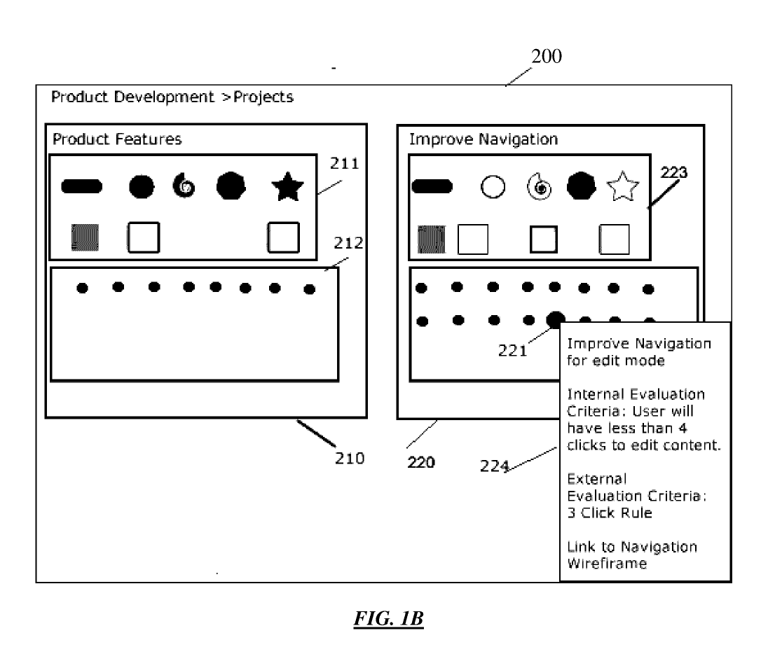

FIG. 1A-B illustrate examples of category representations and presentations according to specific embodiments. In this example, a total of five Categories in three levels are shown. Block 101 shows the items in Category 1a. In this instance Category 1a is labeled “Product Goals”. In this example, the category “Product Goals” has five items as shown. In this example, each item in the Category 1a is represented by a shape icon.

Block 102 displays the items in Category 1b which in this example indicates Customer Goals. The three items in this category are represented as shaded or colored boxes.

Block 103 illustrates one item in Category 3, named in this instance Project Objectives. The item is represented by a black dot. Block 104 shows a legend with the name of all the categories displayed in the Mosaic View.

Furthermore, in this example, each category is represented by text, icon, shape or color and one of the categories is represented by visual grouping or proximity. Block 210 illustrates that one item 210 in Category 2, in this example labeled “Product Features”, is represented as a grouping of items. In this example, borders are shown, but in other examples borders are not shown and groups are indicated by proximity of items. Block 220 is another item in Category 2, labeled “Improve Navigation.”

Icons 211 show items in Categories 1a and 1b that are “aligned with” or otherwise related to or associated with item 210. Icons 212 show items in Categories 3 that are “aligned with” or otherwise related to or associated with item 210.

Icons 223 show items in Categories 1a and 1b that are “aligned with” or otherwise related to or associated with item 220. The icons grouped with 221 show items in Categories 3 that are “aligned with” or otherwise related to or associated with item 220.

Window 224 indicates that when one of the icons (e.g. 221) is indicated by a user or presenter, details regarding that item are presented. This example pop-up window includes details of the indicated Project Objective. The example also shows that a pop-up can contain links to evidence and criteria related to this item.

Thus, according to specific embodiments, FIG. 1A-B illustrate that a first broad category of items or things is represented by a particular color, a second category of items or things is represented by a particular shape, and a third category of items or things is represented by black dots. A fourth category of items or things is represented by groupings (in this case a rectangle) of representations from other categories.

In this example, if items from categories 1a, 1b, or 3 appear in a particular group for category 2, then users can clearly see there is a correlation. If the icon (optionally with its corresponding color, shape, size, etc.) or group does not appear or is blank or white or ‘greyed out,” there is no correlation between the items.

According to specific embodiments, category is a specifically defined division in a system of classification; such as a class. A category can also be a general class of ideas, terms, or things that mark divisions or coordinations within a conceptual scheme. The categories are correlated to show the relations to other categories. For example and without limitation a category might be: a set of course learning outcomes. Another example of a category might be a set of program learning outcomes. Another category might be institutional learning outcomes. A fourth category might be accreditation standards. This method helps map the correlation between the four categories.

In other specific embodiments of the present invention, representations of relationships include audio output. For example, each category of item is represented by a sound and if items in categories 1a, 1b, or 3 are in grouping 2 the sound for that item is played.

In other specific embodiments of the present invention, representations of relationships include sensory output. For example, each category of item is represented by a different type of sensory output. If items in categories 1a, 1b, or 3 are in grouping 2 the sensory output for that item is triggered.

In other specific embodiments of the present invention, representations of relationships include haptic feedback. If items in categories 1z, 1b, or 3 are in grouping 2 the haptic feedback for that item is triggered.

In other specific example embodiments the Multiple Correlated Categories are outcomes, objectives or goals. Each goal can be represented by a color, each outcome is represented by a group, and each objective is represented by a circle.

In other specific example embodiments one or more of the Multiple Correlated Categories are criteria. Categories of outcomes, goals, or objectives are linked to criteria or metric, which define how that items is evaluated or assessed. The criteria or metrics are represented as icons accompanying any category. The criteria or metrics are viewed upon user request.

In other specific example embodiments evidence as described herein comprise examples. These examples can be any type of documents including text or any type characters or semantic representations, video, audio, images, presentations, etc.

In other specific example embodiments, categories can include hierarchical structures. For example a hierarchical structure could be comprised of overarching goals, project objectives, and measurable desired outcomes. Users can see which project objectives and what measurable desired outcomes correlate with which goals.

In other specific example embodiments, categories can include non-hierarchical structures. The non-hierarchical structures might include something like standards from diverse organizations.

Further specific embodiments of the invention include variations and mixtures of the elements described above. While general embodiments can be understood as comprising representations of items from at least three different categories, with at least one category having items represented by groups, at least one category having items represented by a varying representation and at least one category being represented by items represented by a non-varying representation, further combinations and elaborations on these elements are encompassed within the scope of the invention as described in the attached claims.

For example, an item in a category represented by a group can within it (or be aligned to) other items in that category or in another category also represented by a group. Likewise more than one category may be represented by varying icons, for example, a category represented by circles of various shades or colors, another category represented by triangles of various shades and colors, another category represented by squares of various shades and colors, etc. Likewise, one or more categories may be represented by shapes, for example one category represented by icons indicating different vegetables, another represented by icons indicating different meats, another represented by icons indicating different grains or legumes, etc. Likewise, more than one category may be represented by non-varying icons. Several different categories may have items represented by circular black dots, but these can be displayed within separate groups when shown in items of other categories. Likewise, several different categories may have items represented by non-varying icons, but each category may have a different non-varying icon, such as circular black dots, square black dots, and triangular black dots. Various presentation devices can use both visual item indicators and sound or other sensory indicators.

Some, though not all, of these variations are illustrated in the further specific examples provided below.

### 2. Further Example Embodiments

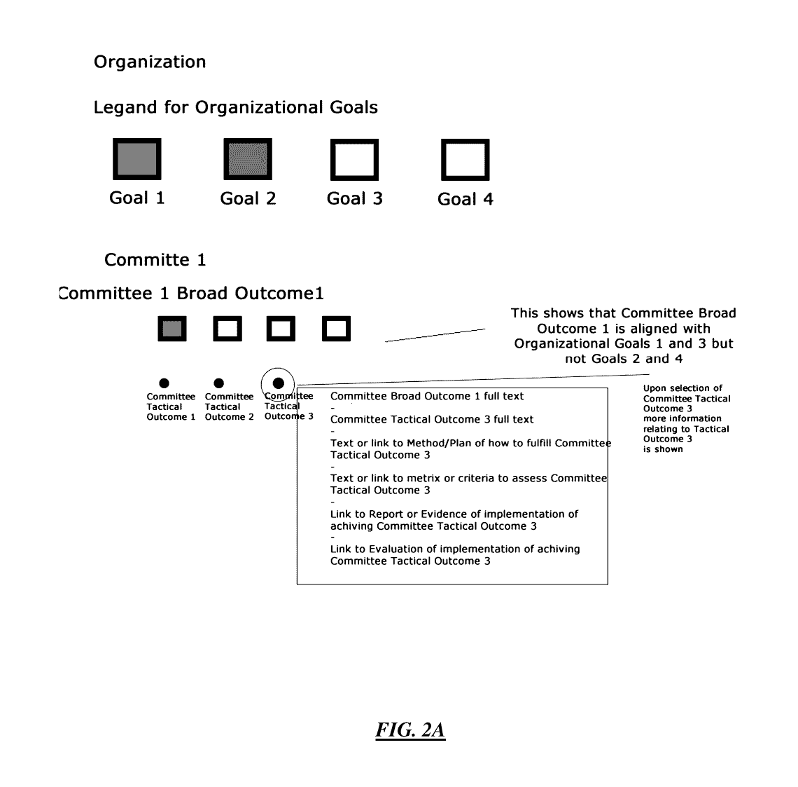

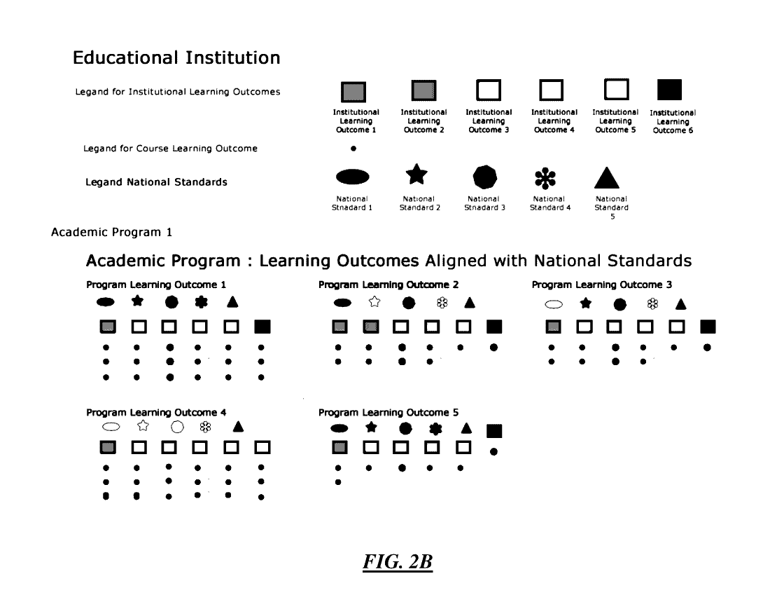

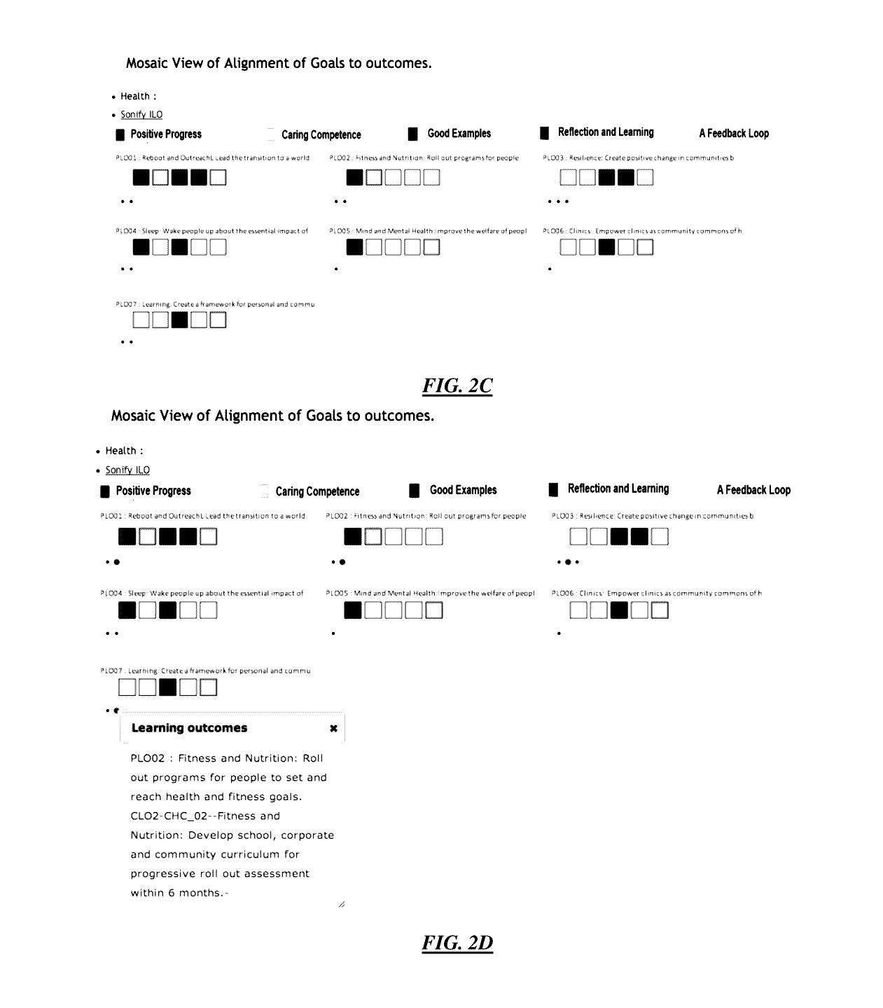

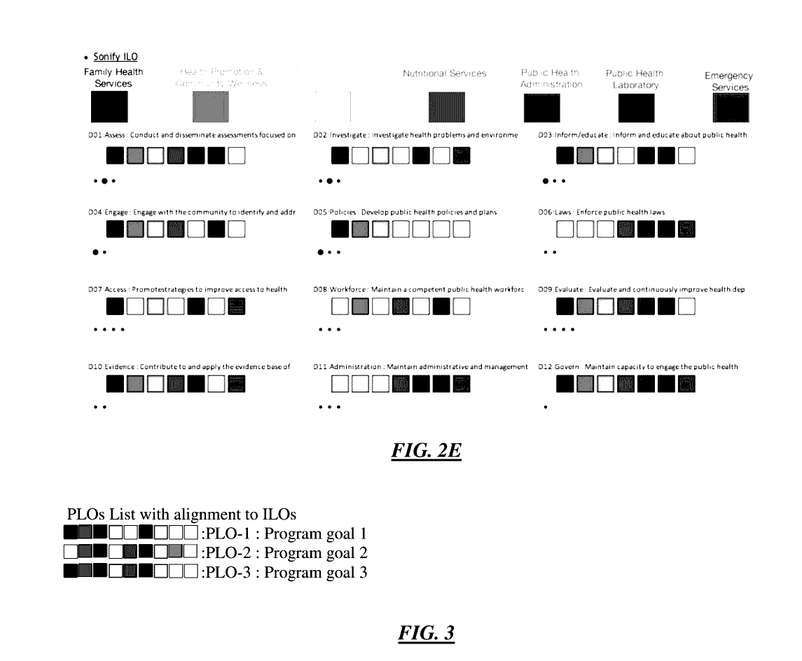

FIG. 2A-E illustrate examples of views (e.g. a Mosaic View™) presenting relationships of items in various correlated categories according to specific embodiments. In these examples, three or four different categories of items are illustrated. In general, the Level 1 categories in these examples have items that are each represented by squares of different shades or colors or are represented by icons of different shapes. Optionally, legends for the items can be indicated as illustrated in some of the figures. Items in categories represented by varying icons, such as shown, can be ordered in one consistent way, as shown in the figure, or can be order in any other way designed to convey various meanings. Categories such as shown may also, optionally, show a blank space or non-filled or white or ‘greyed out” icon to indicate items that are not present, or not aligned, or missing from a particular item in another category.

In general, the Level 2 categories in these examples are represented by groups of items from other categories. Optionally, a descriptive label is also associated with each item group in this category.

In general, the Level 3 categories in these examples include items that are represented by icons that are less variable black dots. In this example, no labels or legends are displayed for these icons until a particular icon is indicated, which displays legends or details or evidence for that icon's item. While icons in these categories generally do not vary to indicate item identity as do Level 1 icons, the icons may vary somewhat in particular embodiments. For example, in the illustrated examples, selecting a particular Level 3 item changes the representation of that item's icon by increasing size and in this case also changing color to red. Notice that the icons in other Level 2 items that are the same as the indicated Level 3 item also change their representation. According to specific embodiments, the examples shown can represent an output on a graphical user interface or a printed output.

### 3. List view

FIG. 3 illustrates an example of presenting relationships of items in categories in a list view according to specific embodiments. This list view can be a supplemental view for items in related categories as discussed herein according to specific embodiments.

### 4. Output of Many Items

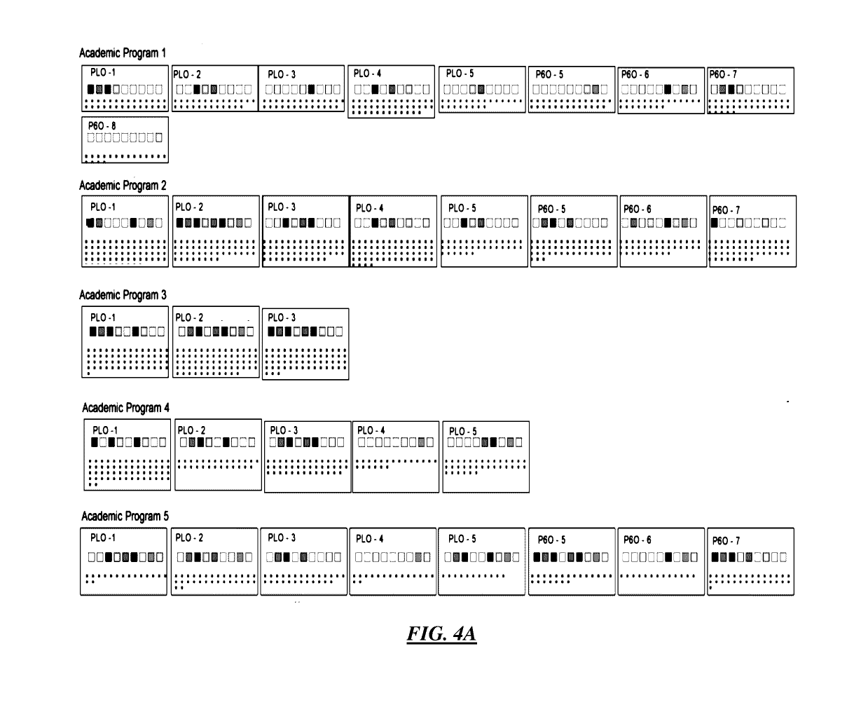

FIG. 4A-B illustrate examples of presenting a number of items in a group category showing alignment or membership of items in other categories according to specific embodiments. According to specific embodiments, FIG. 4 can represent an output on a graphical user interface or a printed output. The figure illustrates that the teachings according to specific embodiments provided herein allow for very flexible presentation of data items. In this presentation, a large number of Level 2 items are shown, with the visual groupings of Level 1 and Level 3 items providing an instant visual summary of how each Level 2 item aligns with items in the other categories.

### 5. Sensory and Audience Participation Examples

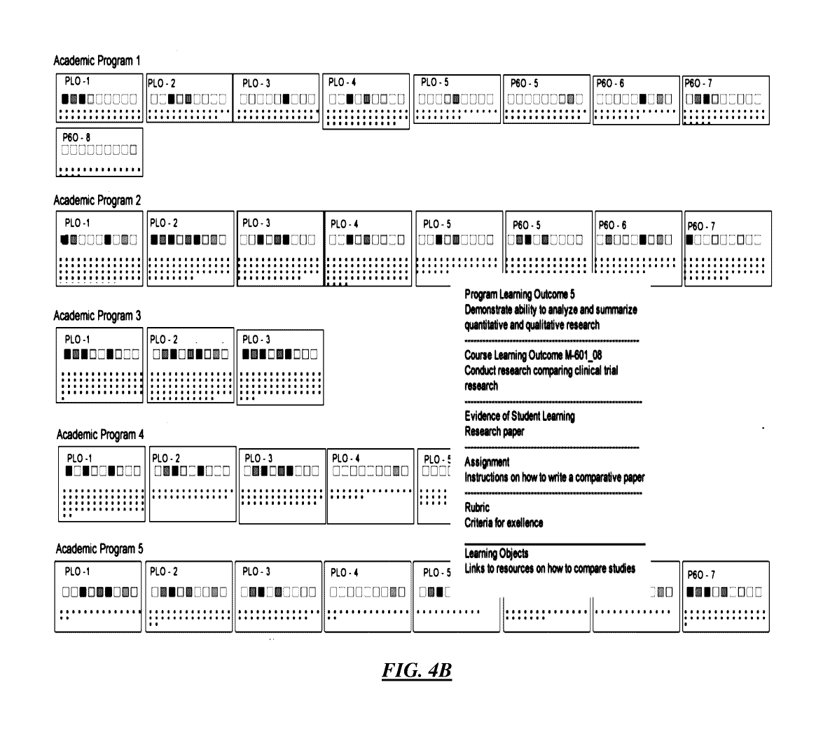

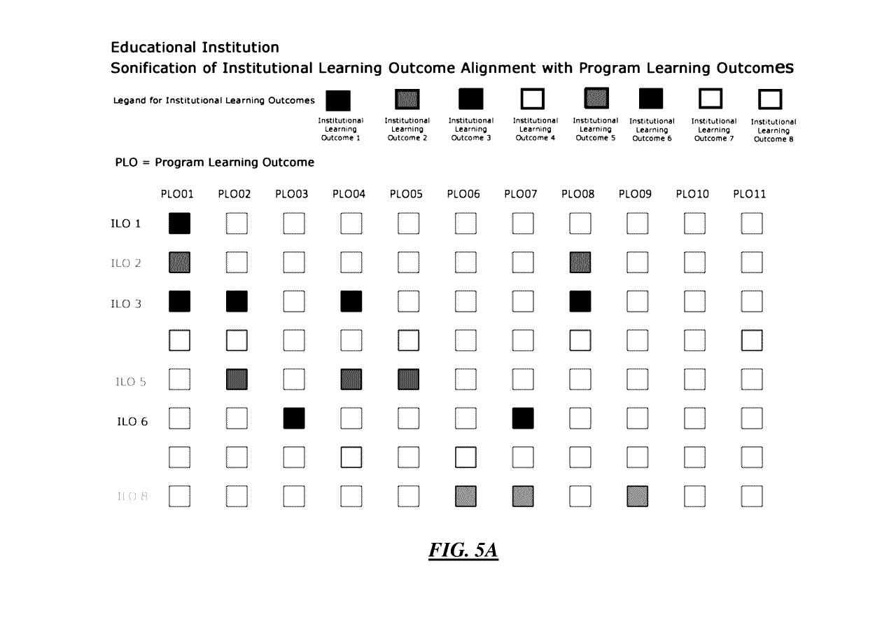

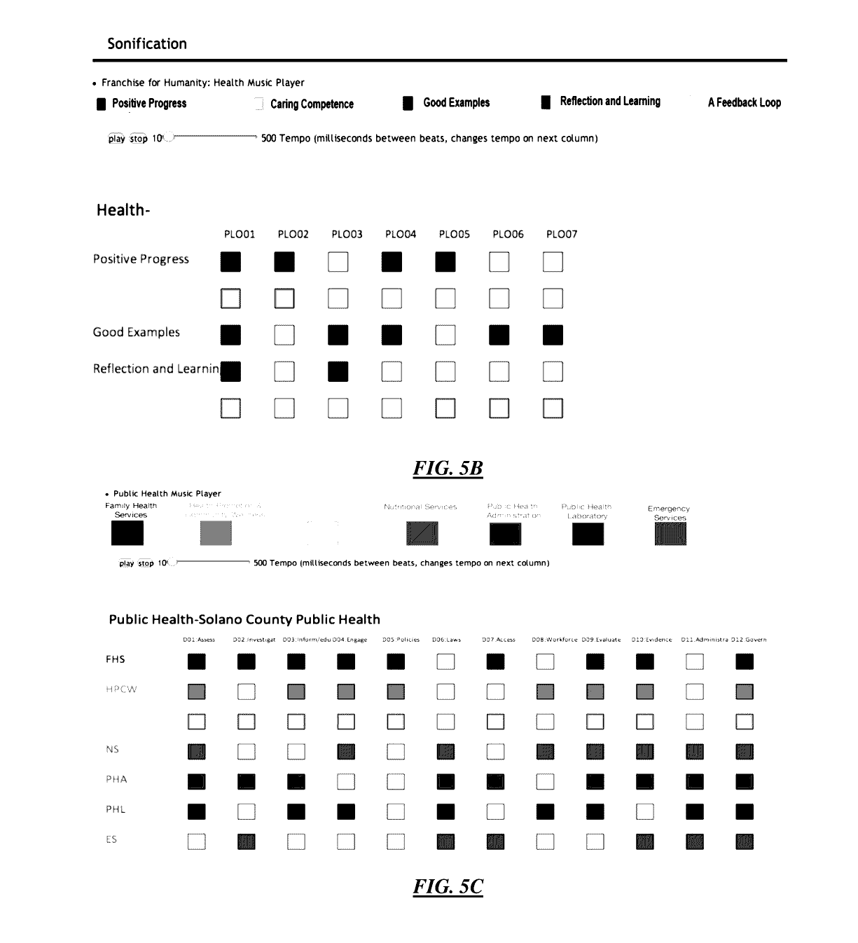

FIG. 5A-D illustrate examples of presenting items in a group category indicated by columns optionally for display along with a sound output according to specific embodiments. Specific embodiments, as discussed herein, provide various item outputs according to categories as described herein. FIG. 5 illustrates an example presentation showing Level 1 categories as square icons of various shades or colors that optionally are also shown by rows and Level 2 categories shown in columns representing groups. Such a display can be used as an alternative presentation by itself or also as a presentation that facilitates further sensory presentations and/or facilitates audience engagement.

In specific embodiments, each item in a Level 2 category is activated to an audience and a sensory output, such as a musical note, is presented. In one example embodiment, each item in category 1 is represented by a different musical note. When an item in category 2 is activated, all of the Category 1 items aligned with that Category 2 item are presented as different notes. The notes can be presented as a chord or as a run of notes. The categories 2 items can be individually can individually indicated or can be played in a sequence, such as left to right in the example shown.

Investigations by the inventors have shown that such a presentation, using sensory outputs, greatly improves audience engagement and understanding of items related with respect to multiple categories. It will be understood by one of skill in the art that volume or rhythm could be used as a variation to indicate different items in Category 1 using sound. It will also be understood by one of skill in the art that other varying sensory outputs, such as vibrations or haptic feedback produced, by example, by a mobile phone or tablet computer, could also be used to indicate the alignment of different Category 1 items with a Category 2 item.

In further specific embodiments, when an item in a Level 2 category is activated or indicated to an audience, such as by highlighting one column in the display shown in FIG. 5, one or more audience members are requested to take an action with respect to the category 1 items aligned with that category 2 item. For example, each audience member can be given a card or other object (such as a piece of wax fruit or vegetable) that corresponds to one item in Category 1 that the member is instructed to hold up when a category 2 item is indicated that aligns with that category 1 item. Alternatively, each audience member can be given the same device, such as a card or clicker, and instructed to activate that device in response to a Category Level 1 item. If audience members are equally divided in assignment to different items in Category 1, the overall audience participation will indicate the level of alignment of a category 2 item with category 1 items.

### 6. Initial Data and Presenter Organization

It will be understood to those of skill in the art that system and methods as described herein can be used with a wide variety of data that is organized according to multiple categories. According to specific embodiments, the initial or raw data related to the invention can include lists of items in any category at any category level and data indicating the other categories related to those items. Such lists can be read into a computer from any data format, such as tables, XML files, spreadsheets, etc.

From the data items with multiple categories, a presented must generally select which specific categories will be Level 1 categories, which Level 2, and which Level 3. Various software tools can be used to facilitate such selection. A presenter may further indicate which representations and variations are used for items in each category.

In further embodiments, one or more interactive tools can be presented to allow a user to indicate moving one or more categories from one level to a different level.

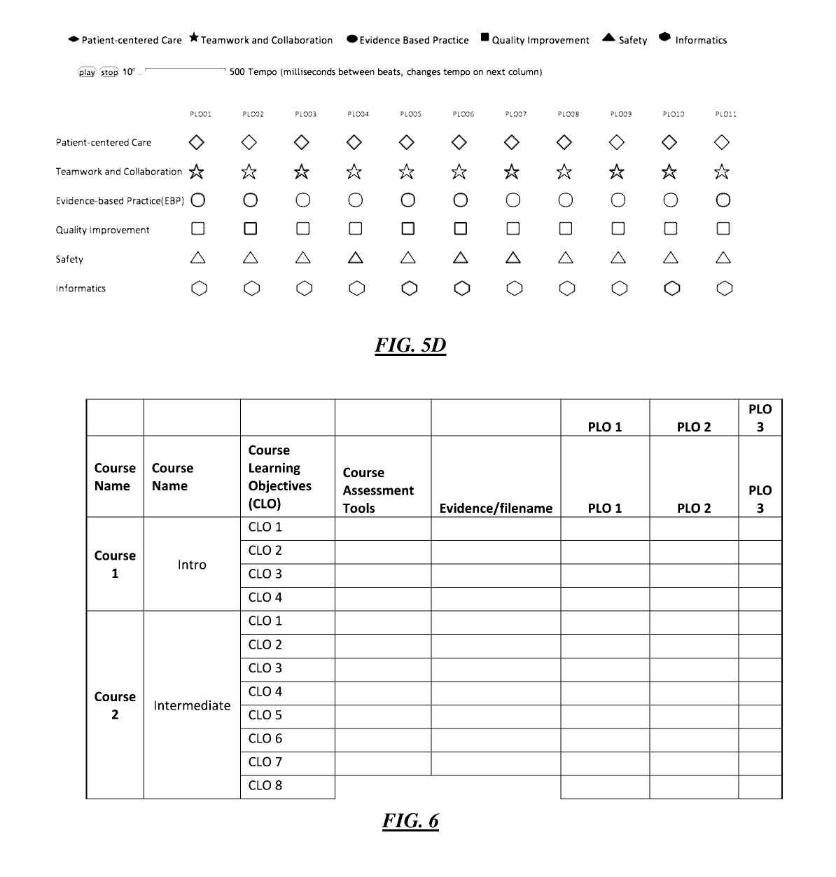

FIG. 6 illustrates an example simple data input template for entering and from which can be read items and categories according to specific embodiments.

### 7. Embodiment in a Logic Processor System

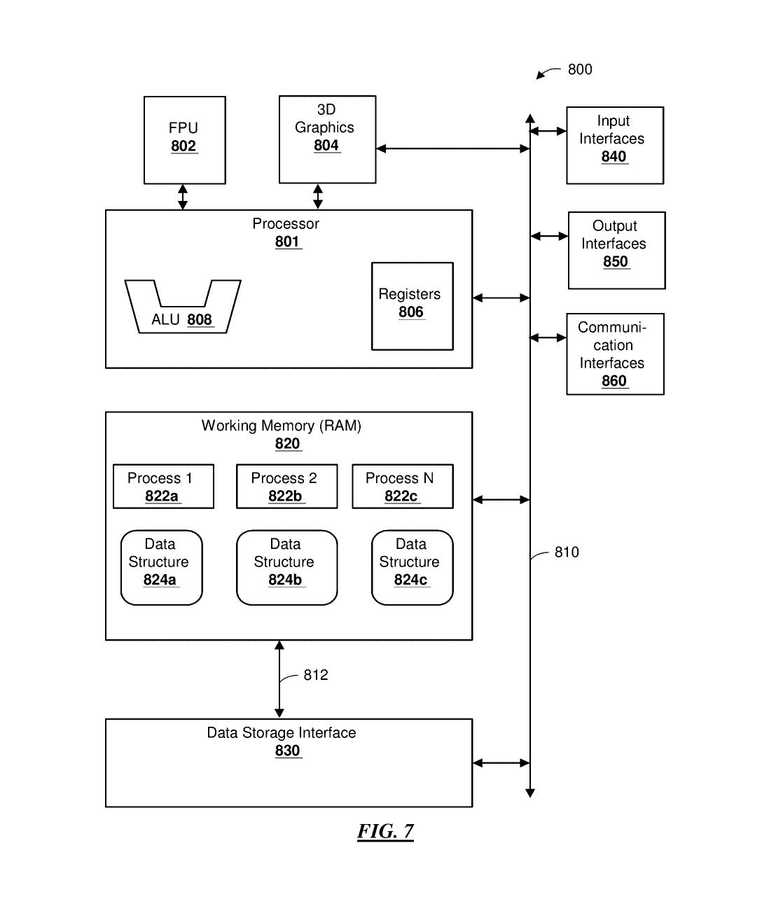

FIG. 7 illustrates an example architecture of an example information handling system relevant to various specific embodiments. As will be understood to those of skill in the art and from the teachings provided herein, the general organization of a system 800 as shown in FIG. 7 is representative of various information systems ranging from computer-on-a-chip type circuits in a household or institutional appliance to various handheld and portable devices, such as tablets and mobile telephones, to workstation, desktop, or super computer systems and distributed systems. In some information handling systems, the various components shown in FIG. 7 may be separable computer chips or separable circuit areas on a computer chip, whereas in other information handling systems, some or all of the functions shown in FIG. 7 will be performed by shared circuitry or implemented in software. Some systems will not have all of the components shown in FIG. 7, and other systems will have additional core components. FIG. 7 does not represent the only device architecture on which the present invention can be performed and it will be understood that the present invention is applicable to a variety of types of information processing devices.

An information handling device typically includes one or more processors, such as 801. Processor 801 is generally characterized as being able to perform different logic operations on data, where logic operations are selected or specified by one or more instructions. In the example of a personal computer system or workstation, processor 801 can represent any of the number of well-known microprocessors manufactured by companies such as Intel, AMD, Zilog, and Motorola. Processor 801 can also represent a subset of circuitry configured as a processor in an integrated circuit such as an ASIC or PLD.

A processor 801 can at times work in cooperation with other information handling circuits (which may or may not also be processors) that may have special-purpose abilities. These circuits may be external from the processor or internal with the processor. As an example, FIG. 7 shows a floating point unit (FPU) 802 and a 3D graphics module 804. A processor 801 may also have a number of structures to facilitate its operation, such as, for example, a set of internal registers 806 and/or an arithmetic logic unit (ALU) 808. In some processors, these structures are internal to the processor circuitry.

In most information handling systems, various modules communicate with other modules over one or more communication paths or buses. FIG. 7 shows a representative system bus 810 and a separate auxiliary bus 812. The illustrated buses can represent signal channels on an integrated circuit, communication connections on a printed circuit board, connection between two or more printed circuit board or a back-plane, or any other channels used by the modules to exchange data or control signals.

In various information processing systems, separable modules can include such things as working memory 820, one or more storage systems 830, one or more input interfaces 840, one or more output interfaces 850. Some information systems also include a communication interface (such as a network interface or a modem) 860 for communicating with other computer systems, such as over a network. These modules are shown in FIG. 7 as broadly representative of aspects of a computing system.

In typical information processing systems, working memory 820 is some type of random access memory (RAM) that can be quickly accessed by processor 801 and possibly by other processors. In general purpose computers and other computer systems, during operation, such a working memory contains the data and instructions for one or more processes 822, including operating system processes. Each process generally represents an executing program or program thread. Working memory 820 can also include one or more data structures 824, which may be associated with particular processes or may be shared or system-wide. These data structures can include data tables or any other data structures that can be represented in digital memory. Therefore, in many general purpose information processing systems (such as personal computers) working memory 820 will be understood in the art as containing resident parts of an operating system and/or of various application systems and/or data files and/or other logic modules or digital data.

As is familiar to those skilled in the art, an information processing system that is a general purpose type computer system further generally includes an operating system and at least one application program. The operating system is a set of logic instructions that control the computer system's operation and the allocation of resources. The application program is a set of logic instructions (possibly also including data) to perform tasks desired by the user. During operation, both may be resident in a memory system such as 820.

Storage 830 is illustrated to represent other, usually more long-term (also called non-volatile) data storage. In general purpose computers, this typically includes one or more disk-type systems (such as hard-disk drives, floppy drives, CD-ROMs, etc.) and can also include a variety of other storage devices. Storage 830 can be used to supplement working memory 820 through a variety of known paging techniques. Storage 830 can also include remote storage systems available over a network. In hand-held devices especially, storage 830 may consist sole of read-only-memory (ROM) used to store executable components of the system. Depending on particular implementations, 830 can represent either storage systems that are part of computer system 800 or an interface to external storage systems.

Input interfaces 840 can represent circuits, devices, and/logic or instructions that can provide for video, audio, keyboard, pointer, other input to a computer system. Typical input devices include such things as a keyboard or keypad, touch-screen, mouse, microphone, camera, environmental sensors (e.g. a thermostat or a motion detection), etc. Input interfaces 840, along with possibly other modules in the computer system, handle tasks involved in translating external data (such as key strokes) to the appropriate encoded data (typically binary data). These translation tasks can involve multiple steps, performed in various parts of a computer system. Depending on particular implementations, 840 can represent input devices and associated interface logic or only interface logic to particular input devices.

Output interfaces 850 represents circuits, devices, and/or instructions that can provide for video, audio, print or other output from a computer system and can also represent actual output devices. Typical output devices include a display screen, a printer, a speaker, etc. Output can also be in the form of control signals to an external machine such as an engine, manufacturing robot or other computer-controlled device. Output interfaces 850, along with possibly other modules in the computer system, handle tasks involved in translating computer encoded data (typically binary data) to the appropriate form for output. These translation tasks can involve multiple steps, performed in various parts of a computer system. A display of base64 encoded data, for example, typically requires a conversion from encoded values to a series of original values. These character codes are then further translated by display driver circuits to produce the electrical signals needed to excite various pixels on a CRT or LCD type display.

Communication interfaces 860 represent circuits, devices, and/or instructions that allow a computer system to communicate with other information handling systems, such as over a telephone dial-up connection or over the world-wide internet.

In accordance with the practices of persons skilled in the art of computer programming, the invention according to specific embodiments is described herein with reference to symbolic representations of operations that are performed by an information processing system. Such operations are sometimes referred to as being computer-executed or processor-executed. It will be appreciated that the operations that are symbolically represented include the manipulation by a CPU or other logic circuitry of electrical signals representing data bits and the maintenance of data bits at memory locations in a memory system, as well as other processing of signals. The memory locations where data bits are maintained are physical locations that have particular electrical, magnetic, optical, or organic properties corresponding to the data bits.

Thus, it will be understood from the teachings herein that the present invention can, according to specific embodiments, be embodied into an information handling system and/or into different separable components of an information handling system.

### 8. Embodiment in a Programmed Information Appliance

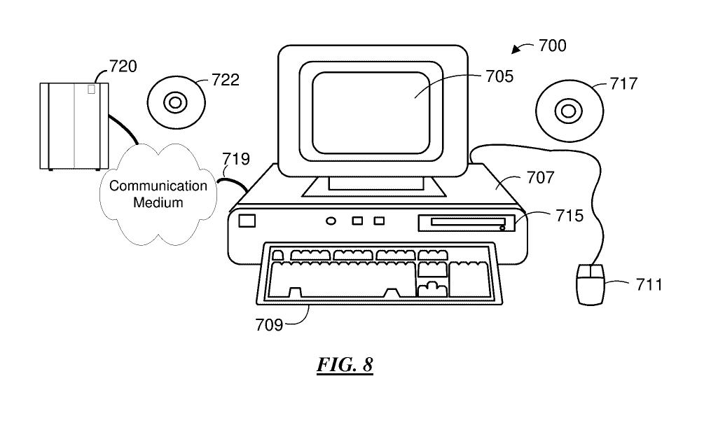

FIG. 8 is a block diagram showing a representative example logic device in which various aspects of specific embodiments may be implemented. As will be understood to practitioners in the art from the teachings provided herein, specific embodiments can be implemented in hardware and/or software. In some embodiments, different aspects can be implemented in either client-side logic or server-side logic. As will be understood in the art, the invention or components thereof may be embodied in a fixed media program component containing logic instructions and/or data that when loaded into an appropriately configured computing device cause that device to perform according to specific embodiments. As will be understood in the art, a fixed media containing logic instructions may be delivered to a user on a fixed media for physically loading into a user's computer or a fixed media containing logic instructions may reside on a remote server that a user accesses through a communication medium in order to download a program component.

FIG. 8 shows an information appliance (or digital device) 700 that may be understood as a logical apparatus that can read instructions from media 717 and/or network port 719, which can optionally be connected to server 720 having fixed media 722. Apparatus 700 can thereafter use those instructions to direct server or client logic, as understood in the art, to embody aspects of specific embodiments as described herein. One type of logical apparatus that may embody the invention according to specific embodiments is a computer system as illustrated in 700, containing CPU 707, optional input devices 709 and 711, disk drives 715 and optional monitor 705. Fixed media 717, or fixed media 722 over port 719, may be used to program such a system and may represent a disk-type optical or magnetic media, magnetic tape, solid state dynamic or static memory, etc. In specific embodiments, the invention may be embodied in whole or in part as software recorded on this fixed media. Communication port 719 may also be used to initially receive instructions that are used to program such a system and may represent any type of communication connection. As will be understood to those of skill in the art, computer system 700 can also be a laptop, tablet or handheld computer or smart phone or mobile phone.

Specific embodiments also may be embodied in whole or in part within the circuitry of an application specific integrated circuit (ASIC) or a programmable logic device

(PLD). In such a case, specific embodiments may be embodied in a computer understandable descriptor language, which may be used to create an ASIC, or PLD that operates as herein described.

### 9. Other Embodiments

Specific embodiments according to one or more descriptions of invention(s) disclosed here have been described. Any use of the term “invention” or “the invention” shall be understood to encompass one or more specific embodiments, but not necessarily all embodiments. The attached claims shall be used as the primary reference to determining the scope of the invention(s) taught herein. Other embodiments will be apparent to those of skill in the art.

For example, a user digital information appliance has generally been illustrated as a personal computer or workstation. However, the digital computing device is meant to be any information appliance for interacting with a remote data application, and could include such devices as a digitally enabled television, cell phone, personal digital assistant, tablet, laboratory or manufacturing equipment, etc. It is understood that the examples and embodiments described herein are for illustrative purposes and that various modifications or changes in light thereof will be suggested by the teachings herein to persons skilled in the art and are to be included within the spirit and purview of this application and scope of the claims.

Furthermore, various different actions can be used to effect presentation of data. For example, a voice command may be spoken, a key may be depressed, a button on a client-side device may be depressed by the user, or selection using any pointing device may be effected by the user.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed:

1. A method for representing or presenting information using a computer system comprising:
representing relationships between items in multiple correlated categories by grouping items in a highest level category and items in a most detailed level category into groups indicating items in a middle level category;
presenting output indicating individual items in the highest level category and in the most detailed level category as one or more groups indicating one or more items in a middle level category;
linking evidence or further details to the items of one or more of said multiple correlated categories; and
presenting said evidence or further details using the computer system once said evidence is requested.

2. The method of claims 1 wherein said representing of relationship is in the form of graphics, illustrations or maps.

3. The method of claims 1 wherein said representing of relationship is in the form of audio, visual, or other sensory (e.g., haptic) output.

4-5. (canceled)

6. The method of claims 1 wherein said multiple correlated categories are one or more of outcomes, objectives or goals.

7. The method of claims 1 wherein said multiple correlated categories are course learning objectives and program level learning objectives and institutional learning outcomes.

8. (canceled)

9. The method of claim 1 wherein said multiple correlated categories are companies, distributors, customers, products, transporters.

10. The method of claim 1 wherein said multiple correlated categories are conference tracks and topics covered in a presentation.

11. The method of claims 1 wherein said evidence are one or more of examples, documents, video or audio, an interface, images, presentations.

12-23. (canceled)

24. A method for presenting a plurality of data items in a plurality of related categories using a logic processing system having a processor, a data storage interface, and a presentation interface, the processor performing the method steps, the steps comprising:
reading data indicating a plurality of items in a plurality of categories from the data storage interface;
reading data indicating at least one representation type for each of the categories from the data storage interface;
reading data indicating variations for at least one representation type from the data storage interface; and
outputting to the presentation interface a plurality of items in at least three different categories, at least one category represented by a grouping of items from at least two other categories.

25. The method of claim 24 further comprising:
wherein the representation types comprise three or more of text, variable icons, invariable icons, and groups; and
wherein the representation variations comprise two or more of text content, size, shape, shade, and color.

26. The method of claim 24 further comprising:
wherein the representation types comprise two or more of: text, variable icons, invariable icons, groups, sounds, notes, vibrations, haptic feedback, other sensory output; and
wherein the representation variations comprise two or more of: text content, size, shape, shade, color, volume, brightness, tone, vibration pattern, vibration strength, other sensory output variations.

27. The method of claim 24 further comprising:
providing an audience participation interface for items in at least one category.

28. The method of claim 27 further wherein:
the audience participation interface comprises one or more of:
a card or other object that is held up by an audience member when a particular item in the at least one category aligns with an indicated item in another category;
a keyboard or button or other electronic input that is activated by an audience member when a particular item in the at least one category aligns with an indicated item in another category;
a clicker, tone generator or other sound generating device that is activated by an audience member when a particular item in the at least one category aligns with an indicated item in another category; and
a light emitting device that is activated by an audience member when a particular item in the at least one category aligns with an indicated item in another category.

29. The method of claim 28 further wherein:
each participating audience member is provided with a participation interface that is activated when one particular item in one category is indicated during a presentation.

30. The method of claim 24 further comprising:
reading from a user interface user input indicating one of one or more categories or one or more items for details output;
reading from an evidence and details data store, evidence and data linked to the items in of one or more of the multiple categories; and
outputting to the presentation interface one or more details or evidence associated with an item when the item is indicated by a user.

31. The method of claim 24 further comprising:
reading from a user interface user input indicating modification of one or more categories or one or more items; and
reading from a user interface user input enabling a user to link evidence to one or more items.

32. The method of claim 24 further comprising:
reading from a user interface user input indicating which categories should be represented as groups.

33. The method of claim 24 further wherein:
the output module can output a plurality of items in at least three categories in at least two output variations, swapping a group representation of one category with a non-group representation, and swapping a non-group representation of one category with a non-grouping representation.

34. A system for displaying information comprising:
one or more processors configured to provide:
a category data store that stores a plurality of categories and a plurality of different items associated with those categories;
a representation data store that stores a plurality of representation types for the categories;
an item data store that stores a plurality of representation variations for different items in the categories;
an evidence data store that stores evidence linked to the items in of one or more of the multiple categories;
wherein the representation types comprise three or more of text, variable icons, invariable count icons, and groups;
wherein the representation variations comprise two or more of: text content, size, shape, color;
an output module that outputs a plurality of items in at least three different categories, at least one category represented by a grouping of items from at least two other categories;
a user interface that allows a user to indicate one of one or more categories or one or more items for output; and
a details output module that outputs details or evidence associated with an item when indicated by a user.

35. The system of claim 34 further wherein:
the user interface allows a user to add or modify one or more categories or one or more items; and
the user interface allows a user to link evidence to one or more items.

36. The system of claim 34 further wherein:
one or more group representations of one or more categories can contain other groups.

37. The system of claim 34 further wherein:
the user interface allows a user to indicate which categories should be represented as groups.

38. The system of claim 34 further wherein:
the output module can output a plurality of items in at least three categories in at least two output variations, swapping a group representation of one category with a non-group representation, and swapping a non-group representation of one category with a non-grouping representation.

39-50. (canceled)
